(19) United States
(12) Patent Application Publication
(10) Pub. No.: US 2025/0173604 A1
(43) Pub. Date: May 29, 2025

(54) ARTIFICIAL INTELLIGENCE (AI) FOR HARDWARE/SOFTWARE CO-DESIGN OF ACCELERATORS AND MACHINE LEARNING MODELS

(71) Applicant: HEWLETT PACKARD ENTERPRISE DEVELOPMENT LP, Spring, TX (US)

(72) Inventors: PEDRO HENRIQUE ROCHA BRUEL, Spring, TX (US); Giacomo Pedretti, Cemusco sul Naviglio (MI), Milano (IT); Sergey Serebryakov, Milpitas, CA (US); John Moon, Spring, TX (US)

(21) Appl. No.: 18/522,791

(22) Filed: Nov. 29, 2023

(51) Int. Cl. G06N 20/00

(52) U.S. Cl. CPC G06N 20/00

(57) ABSTRACT

Systems and methods are provided for iteratively co-designing hardware and software elements of a device configuration to optimize it. This process can predict how software parameters and hardware parameters will perform in the device configuration using a machine learning process that simulates how the device configuration will perform. The corresponding input (e.g., software/hardware parameters) and output (e.g., model accuracy evaluation value for software parameters and hardware cost estimation value for hardware parameters) determined from the machine learning process can be used for various purposes, including used to train a machine learning (ML) model to select the optimized device configuration in view of the various constraints.

### BACKGROUND

Processors are used to execute machine readable instructions that cause the processor to perform various actions on the computer system. In some examples, the actions implement machine learning models and other high-performance computing operations. The characteristics of the processor can determine how fast, accurate, and efficient the processor performs when processing these actions. For example, general graphics processing units (GPU) can execute models that other processors may also be able to execute, however other processors may perform the same tasks slower and potentially inaccurately. Indeed, the correct hardware configuration for the processing task can improve in the overall effectiveness of the system.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a hardware and software co-design system, in accordance with some examples of the system.

FIG. 2 is a decision tree ensemble, its mapping to a hardware device, and a prediction step, in accordance with some examples of the system.

FIG. 3 illustrates a process for generating hardware and software optimization configurations using the hardware and software co-design system, in accordance with some examples of the system.

FIG. 4 illustrates a process optimization using the hardware and software co-design system, in accordance with some examples of the system.

FIG. 5 illustrates a machine learning regression model, in accordance with some examples of the system.

FIG. 6 illustrates an Expected Improvement Acquisition function, in accordance with some examples of the system.

FIG. 7 illustrates pseudo-code of computer readable instructions for level-two co-design using a machine learning regression process with active learning, in accordance with some examples of the system.

FIG. 8 illustrates optimization metrics, in accordance with some examples.

FIG. 9 illustrates an example computing component that may be used to implement hardware and software co-design in accordance with some examples of the system.

FIG. 10 is an example computing component that may be used to implement various features of embodiments described in the present disclosure.

The figures are not exhaustive and do not limit the present disclosure to the precise form disclosed.

### DETAILED DESCRIPTION

Modern artificial intelligence (AI) workloads process large data sets, which is not ideal in standard or generically-configured hardware processors. Some hardware processors are purpose-built as an accelerator for accelerating a specific function or workload. Even when the processor is configured as an accelerator for a particular purpose, the processor/accelerator can handle a wide range of workloads but rarely embodies an optimal configuration for specific functions or workloads. Some administrative users may adapt hardware processors to ML workloads or other software-based processes, although this is often a manual process and resource intensive to create these configurations. Designing new hardware for specific applications and implementing software that leverages hardware specificity are interdependent problems that should be tackled jointly to maximize improvements. Optimizing design of both hardware and software components presents many challenges and may require frequent communication between hardware and software experts, and can be time-consuming and inefficient if dealt with separately.

Examples of the disclosure iteratively determine hardware and software configurations by co-designing these elements to form an optimized system configuration. This process can determine software parameters and hardware components, and is applicable to general search spaces (e.g., the finite hardware and software configuration space to search) and optimization target variables (e.g., the features of a software/hardware pair to maximize in the outcome of the model). For example, the system may first sample the search spaces of hardware and software configurations to determine software parameters, model parameters, and/or hardware parameters. The software or model parameters (used interchangeably) comprise values associated with a software application, including a type of ML model, a size of data, a size of a software program, and other measurable characteristics of the software that can be stored as software parameters. Hardware parameters comprise values associated with a hardware device, including a type of hardware device, a size of memory or other device component, a speed of processor, and other measurable characteristics of the hardware that can be stored as hardware parameters.

Upon determining the parameters, the system may determine a first device configuration associated with the parameters. For example, the latency, area, and throughput of the first device configuration may be determined/estimated using a closed-form hardware cost model, where metrics associated with the first device configuration are measured in a simulated environment that implements the device configuration with hardware and software parameters. The model of the machine learning regression process may be implemented in a simulated or virtual environment using the software parameters and hardware parameters determined from the configuration sample, and used to generate metrics associated with the first device configuration.

In some examples, the machine learning process is a Gaussian Process regression with active learning, although other forms of machine learning processes may be implemented without diverting from the disclosure. Active learning refers to a type of machine learning where the learning algorithm can interactively query an information source to label new data points with particular values (e.g., using Botorch® or GpyTorch® packages). The machine learning process may iteratively and sequentially simulate various device configurations with different hardware and software parameters.

The predicted metrics from the simulation may comprise a model accuracy evaluation value and a hardware cost estimation value of each device configuration. A model accuracy evaluation value comprises a value corresponding with a relative amount of accuracy in the output of the software (e.g., ML model, software/model parameters) when combined with the particular configuration of the hardware processor (e.g., hardware parameters). A better model accuracy evaluation value may be maximized in comparison to other model accuracy evaluation values. On the hardware side, the hardware cost estimation value comprises values to maximize or minimize corresponding with the hardware parameters of a device configuration, including latency (minimize), area (minimize), throughput (maximize), and other hardware cost values.

The model accuracy evaluation value and the hardware cost estimation value may be generated simultaneously. For example, the machine learning process can apply the device configuration in the simulated environment using the corresponding sets of hardware parameters and software parameters. These parameters may be applied at the same time and for a single configuration pair. Once the sets of hardware parameters and software parameters are simulated, the process can wait/delay execution of the next iteration of the process until the output is determined. In some examples, the process can wait to determine the output from the previous simulation that can help guide the selection of the next set of hardware parameters and software parameters. The selection of parameters in the two spaces of parameters (hardware and software) is performed at the same time in a joint manner, guaranteed by the Expected Improvement acquisition function.

The simulated output may be used in various ways. For example, the simulated output may be used to train an ML model, which can apply weights and biases that may tune and optimize any values associated with the simulated output. The output from the ML model can determine a new device configuration that maximizes output for corresponding with hardware parameters and software parameters. For example, the new device configuration can maximize a model accuracy evaluation value and minimize a hardware cost estimation value for the new device configuration at the same time. In some examples, the output may be used to train a ML model during additional levels of training of device configurations, or may predict a device configuration that maximizes output for corresponding hardware/software parameters.

Technical improvements are provided throughout the process. On the hardware side, the optimized solution can deliver low latency, high throughput, and comply with physical limitations (e.g., the area available on a silicon chip) and power constraints. On the software or application side, effective model implementations can leverage the individually-chosen hardware for the software implementation in order to deliver accurate and fast inference of the ML model (e.g., Ensembles of Decision Trees). In some examples, an active learning Gaussian Process Regression model is used to decide where in the search space to explore to test the next available implementation of hardware and software to work together.

In some examples, the process can improve machine learning model as well. For example, the system can help identify fewer decision trees in decision ensembles while simultaneously mapping more decision trees to each hardware device configuration. Joint optimization may also reduce the precision of features for software parameters derived in each device configuration by performing feature binning without losing model accuracy, while optimizing hardware performance and enabling large throughput improvements.

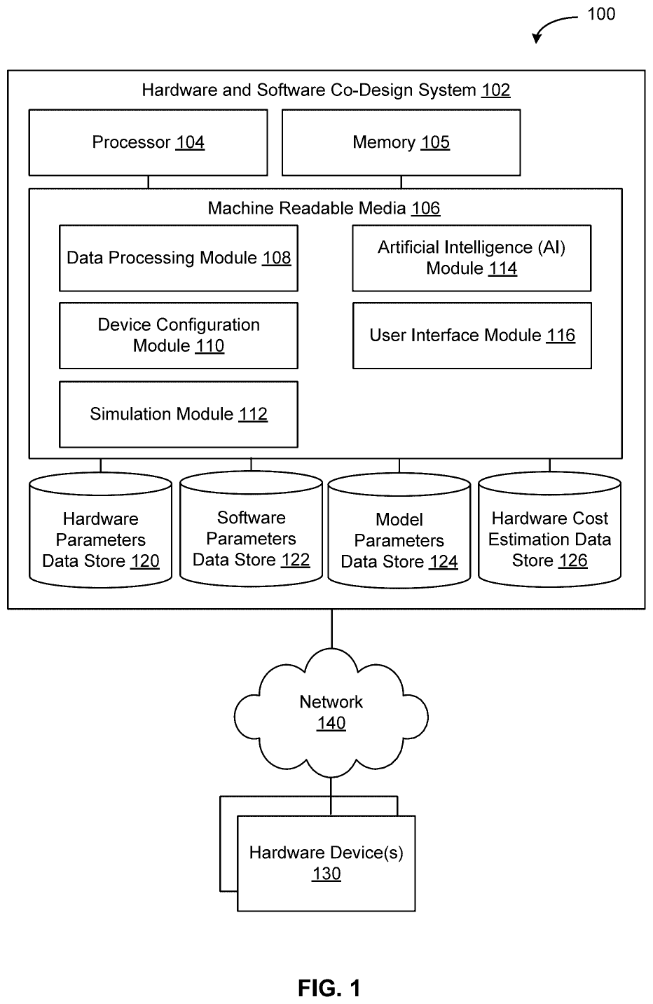

FIG. 1 illustrates a hardware and software co-design system, in accordance with some examples of the system. In example 100, hardware and software co-design system 102 is illustrated in communication with network 140 and a set of hardware devices 130. Hardware and software co-design system 102 comprises processor 104, memory 105, and machine readable media 106 for storing computer-readable instructions for performing various operations discussed herein. The set of hardware devices 130 may comprise second and separate processors, memory, and software components (not shown) for implementing the device configuration determined by hardware and software co-design system 102.

Processor 104 may comprise a general-purpose or special-purpose processing engine such as, for example, a microprocessor, controller, or other control logic. Processor 104 may be connected to a bus, although any communication medium can be used to facilitate interaction with other components of hardware and software co-design system 102 or to communicate externally.

Memory 105 may comprise random-access memory (RAM) or other dynamic memory for storing information and instructions to be executed by processor 104. Memory 105 might also be used for storing temporary variables or other intermediate information during execution of instructions to be executed by processor 104. Memory 105 may also comprise a read only memory (“ROM”) or other static storage device coupled to a bus for storing static information and instructions for processor 104.

Machine readable media 106 may comprise one or more interfaces, circuits, and modules for implementing the functionality discussed herein. Machine readable media 106 may carry one or more sequences of one or more instructions processor 104 for execution. Such instructions embodied on machine readable media 106 may enable hardware and software co-design system 102 to perform features or functions of the disclosed technology as discussed herein. For example, the interfaces, circuits, and modules of machine readable media 106 may comprise, for example, data processing module 108, device configuration module 110, simulation module 112, artificial intelligence (AI) module 114, and user interface module 116. Various data stores may also be maintained by hardware and software co-design system 102, including hardware parameters data store 120, software parameters data store 122, model parameters data store 124, and hardware cost estimation data store 126.

Data processing module 108 is configured to receive a set of hardware parameters and a set of software parameters for configuring a device that complies with individual ones of the set of hardware parameters and individual ones of the set of software parameters. As discussed herein, software or model parameters (used interchangeably) comprise values associated with a software application, including a type of ML model, a size of data, a size of a software program, and other measurable characteristics of the software that can be stored as software parameters. Hardware parameters comprise values associated with a hardware device, including a type of hardware device, a size of memory or other device component, a speed of processor, and other measurable characteristics of the hardware that can be stored as hardware parameters.

In some examples, once the set of hardware parameters and a set of software parameters for configuring a device are received as a dataset and selected by hardware and software co-design system 102, data processing module 108 may not further interact with the parameters and instead may rely on various device configurations generated by device configuration module 110.

Device configuration module 110 can determine a first device configuration for the device using a first set of hardware parameters from the set of hardware parameters and a first set of software parameters from the set of software parameters. Device configuration module 110 can also determine a second device configuration using the first software model accuracy evaluation value and the first hardware cost estimation value from the ML model (implemented by AI module 114).

In a device configuration, hardware and software constraints may be considered. For example, on the hardware side, device configuration module 110 can consider optimizing features to deliver low latency, high throughput, and comply with the physical limitations (e.g., the area available on a silicon chip) and power constraints of the hardware. On the software or application side, device configuration module 110 can consider optimizing features to leverage the hardware to deliver accurate and fast inference of the model. The system may require frequent communication between hardware and software components of the simulated device configuration.

Device configuration module 110 is also configured to provide the device configuration to simulation module 112 to evaluate the corresponding hardware parameters and software parameters of the device configuration in the simulated or virtual environment. The simulations may be executed sequentially, so that the output from a first simulation may be used in the second simulation.

Various evaluation techniques may be implemented to determine how the configuration will perform, including the use of a machine learning model like a Gaussian Process Regression model, and the next set of hardware parameters and software parameters may be selected using active learning methods. Other types of evaluation techniques may be implemented without diverting from the essence of the disclosure, including a multi-armed bandit model, global optimization, Pareto optimum, or other probabilistic processes. For example, the machine learning process may determine output from a particular device configuration and active learning may select the next hardware parameters and software parameters to test using the gaussian process regression model (e.g., to determine the model accuracy and hardware cost values).

The system also identifies the next parameters corresponding with a particular device configuration to sample using active learning. The next parameters and configuration may be provided back into the machine learning process to sequentially determine the optimization values of different configuration settings. The process may stop determining of device configurations when the output corresponding with the hardware parameters and the software parameters exceeds a pre-determined threshold value (e.g., the threshold value being a particular optimization value is determined or some amount of improvement between the hardware and software configurations increase less than a threshold value).

The machine learning process may seek to optimize hardware and software metrics for an optimized device configuration. A normalized array of measurements “y” corresponding to a parameter sample “X” is written as:

$$y = 𝒫 ( X ) = z ( {\sum }_{i} z ( {𝒫}_{i} ( X ) ) ) , where z ( X ) = \frac{X - \hat{μ} ( X )}{\hat{σ} ( X )} . \qquad ( 1 )$$

Using this formula, the system may seek to optimize various hardware and software metrics. For example, using three hardware metrics and one software metric, the system can minimize the hardware area, hardware latency, and model's root mean square error (RMSE) performance metric, while hardware throughput and model accuracy may be maximized. The metrics may be combined in a single scalarization and the system may compute scores (Z-scores) for each metric independently for the sum of normalized metrics. The system may define the objective function ƒ(x)=y as a single-output real-number function of a vector of hardware and software parameters.

In some examples, device configuration module 110 (with simulation module 112) may find a best compromise for hardware that is capable of running corresponding software, like a large set of optimized models. The system may explore models and specialized hardware together to determine the best trade-off.

Simulation module 112 is configured to determine a simulated output from the device configuration determined by device configuration module 110. For example, simulation module 112 may generate, in a virtual environment, concurrent systems where the Instruction Set Architecture (ISA), microarchitecture, and memory interact with the programming model and communications system. Some examples may incorporate components of a virtualized processor, memory, disk, network, and software models. The simulator may remain unchanged as it accepts various hardware parameters and software parameters as input and determines event types or values as output. For example, during a simulation, simulation module 112 may determine events associated with computation, communication (e.g., message passing interface (MPI) events), sleep, or memory reads, and the corresponding values associated with such events.

In some examples, simulation module 112 may apply the first set of hardware parameters and the first set of software parameters to the ML model (implemented by artificial intelligence (AI) module 114). The output of the model may help determine when and how much time is spent executing processes for these events, in addition to other metrics discussed herein.

In some examples, simulation module 112 may receive a parameter that is provided in a parallel simulation environment based on MPI events. This process can provide a high level of performance and the ability to look at large systems. The model may determine predicted output of the device configurations ranging from processing in memory to conventional processors connected by conventional network interfaces and running MPI.

In some examples, simulation module 112 may implement the simulation on an external system or using a toolkit (e.g., Structural Simulation Toolkit (SST)). As an external system, the simulation may virtualize the software and hardware components of the device configuration where the ISA, microarchitecture, and memory interact with the programming model and communications system, while effects of the configuration are measured. The measurements may be provided back to simulation module 112. In this sense, simulation module 112 may enable a modular design that enables measurement of an individual system parameter without changing components of simulation module 112 or provide a parallel simulation environment based on MPI.

Artificial intelligence (AI) module 114 is configured to determine the output from the first device configuration by applying the first set of hardware parameters and the first set of software parameters to the ML model. The output from the ML model generates a first software model accuracy evaluation value and a first hardware cost estimation value, simultaneously, for the first device configuration that complies with the first set of hardware parameters and the first set of software parameters.

In some examples, AI module 114 implements a tree-based model inference of the co-design process. The inference may determine the trade-offs between software and hardware metrics, like software/model accuracy and hardware area, latency, and throughput. The ML model may correspond with a linear regression model or multi-objective Gaussian Process (GP) Regression model to merge hardware and software search spaces. This process may identify the joint space using active learning acquisition functions (e.g., the Expected Improvement (EI) criterion).

In some examples, the ML model is a Gradient Boosted Decision Tree Ensemble. For example, given an input point x=(x₁, . . . , x_{K}), where K is the number of input dimensions or features, and a function ƒ(x)=y, where y is a real number or a class label, the learning problem consists of using data (X, y=ƒ(x∈X)) to build a predictor \hat{ }ƒθ capable of estimating ƒ(x′) for new points x′ not in X.

In some examples, a binary decision tree ensemble performs the inference. The binary decision tree ensemble is [symbol] ={T₁, . . . , T_{P}}, where P is the number of trees in the ensemble. The inference is executed by comparing input feature values x₁, . . . , x_{K} to thresholds in the nodes of each tree.

In some examples, each node compares a single threshold to a single feature. The features can appear on multiple nodes and the trees may not be balanced. Any partial predictions of the tree may consist of single paths taken by each input point, and the leaves reached by each tree in the ensemble are combined in a subsequent reduction step. This may produce the final regression or classification prediction y\hat{ }=ƒ\hat{ }θ (x′), where θ consists of the thresholds and parameters of the tree ensemble.

AI module 114 may implement a training process of the ML model. The training may consist of training the tree ensemble model using the Gradient Boosted Decision Trees algorithm, where each new tree is fit iteratively to the partial residuals of the ensemble. The process may expose many parameters for configuring and constraining the resulting tree ensemble and the training process, such as the maximum number of trees, the learning rate, and implementing different subsampling methods.

In some examples, the ML model may implement feature binning. For example, feature binning may divide continuous or other numerical features into distinct groups. This may allow the ML model to emphasize important trends in the data by focusing the feature binning on tree splits in the decision tree ensemble.

In some examples, the performance of tree ensemble models may be measured by the percentage of accurate predictions for classification, and Root Mean Squared Error (RMSE) for regression tasks.

AI module 114 may compare the accuracy values with threshold values or previous accuracy values. The comparison may include, for example, comparing the second device configuration with a second software model accuracy evaluation value. In another example, the comparison may include comparing a second hardware cost estimation value with a first software model accuracy evaluation value and the first hardware cost estimation value of the first device configuration. When the second values are greater than the first values, the second device configuration may be provided to the interface (via user interface module 116).

User interface module 116 is configured to provide a device configuration to a display. For example, the device configuration may use a set of hardware parameters from the set of hardware parameters and a set of software parameters from the set of hardware parameters that optimized the determined metrics. The device configuration may include, for example, a device configuration that is better than other device configurations in one or more of low latency, high throughput, hardware configuration that can fit within chip area, maintain power constraints, deliver accurate and fast inference of the ML model, or other metrics described throughout.

Hardware parameters data store 120 comprises values associated with a hardware device, including a type of hardware device, a size of memory or other device component, a speed of processor, and other measurable characteristics of the hardware that can be stored as hardware parameters. An illustrative hardware device may include an analog Content Addressable Memory (aCAM) and the corresponding hardware parameters for the aCAM device may include a number and type of cells in the aCAM, various organization structures of the aCAM cells such as height and width of groups of aCAM cells, various organization structures of the Network-on-Chip (NoC) communication fabric between aCAM cells such as tree branching and depth, various memory buffer sizes such as buffers on each level of the NoC, and various pipeline parameters such as pipeline depth and bubble sizes.

Software parameters data store 122 comprises values associated with a software application, including a type of ML model, a size of data, a size of a software program, the software execution time and memory and power consumption, and other measurable characteristics of the software that can be stored as software parameters.

Model parameters data store 124 comprises values associated with the ML model, including a type of algorithm (e.g., ensemble of decision trees or neural network), machine learning process (e.g., a Bayesian Optimization process with a Gaussian Process Regression, or other generic Bayesian approach), or other model parameter values such as, for ensembles of decision trees, tree depth and number of leaves, number of features per tree, number of trees, learning rate of the gradient boosting algorithm, various subsampling parameters that operate on the data set such as column (feature) subsampling, row (or data point) subsampling per tree, and feature binning or precision.

Hardware cost estimation data store 126 comprises cost and constraint functions of the optimization problem that the Gaussian process uses to optimize, such as hardware latency, area, and throughput.

Hardware device 130 comprises various devices that may be configured in accordance with the simulated device configuration. For example, the device may include a GPU, which may be a common accelerator for machine learning functionality and may be well-suited for parallelism. Some devices may implement fast non-uniform memory access and overcome various memory constraints that can be encountered when running ML models, processes, and fast non-uniform data access.

In some examples, hardware device 130 comprises an aCAM architecture (e.g., for Tree Ensemble Inference). An aCAM is a type of CAM that compares analog inputs to stored intervals, returning a match when all inputs are within intervals. An ensemble can be mapped to an aCAM array by disposing input features on the aCAM columns, and each tree root-to-leaf paths on the aCAM rows. The threshold values can then be programmed in each aCAM cell, and traversing all trees to find each selected leaf, stored in separate RAM, can be performed in a single aCAM matching operation for each input point. The aCAM architecture may implement parallel in-memory and overcome irregular memory access pattern issues.

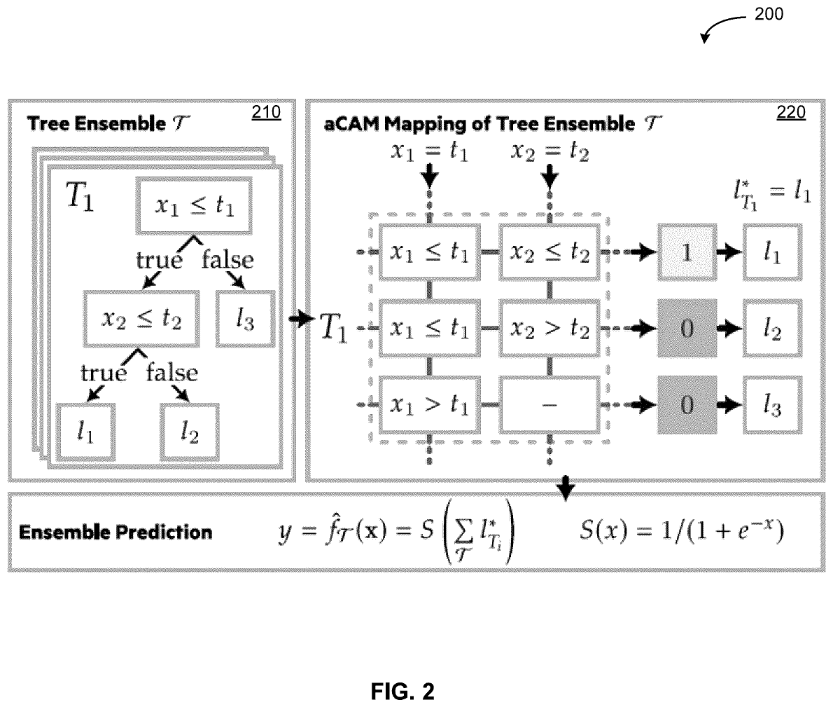

FIG. 2 is a decision tree ensemble, its mapping to a hardware device, and a prediction step, in accordance with some examples of the system. In example 200, decision tree ensemble 210, mapping 220 to a hardware device (e.g., an aCAM array), and ensemble prediction 230 are provided. Mapping 220 to a hardware device (e.g., an aCAM array) illustrates an aCAM-based architecture that consists of cores with aCAM arrays with a given number of rows and columns that are arranged in stacks and queues. The cores may be interconnected by a configurable H-tree Network on Chip (NoC). Ensemble prediction 230 illustrates how the one way that leaf values can be reduced in the inference process. In this exploratory architecture design stage, parameters are free to change and explore trade-offs between hardware performance metrics such as area, latency, and throughput.

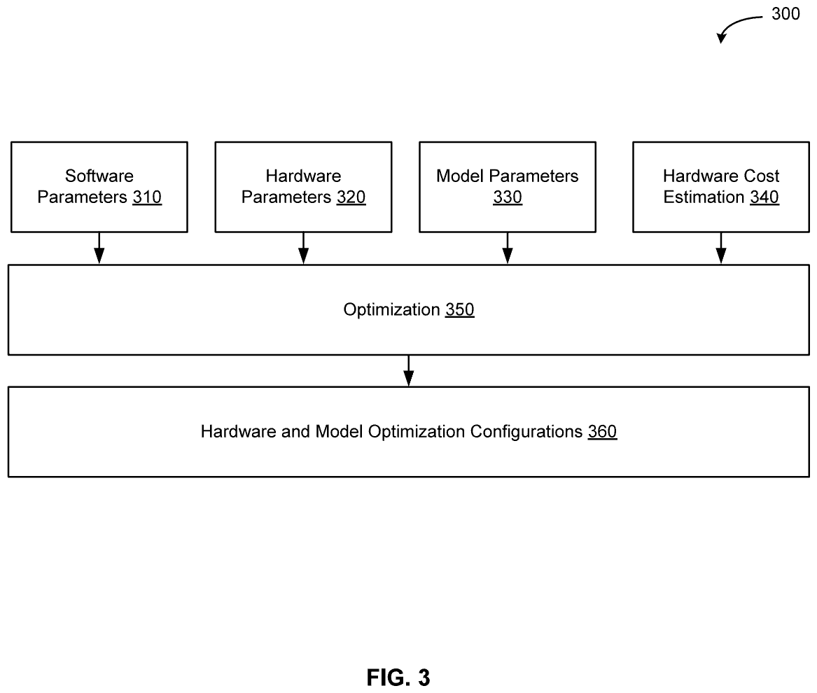

FIG. 3 illustrates a process for generating hardware and software optimization configurations using the hardware and software co-design system, in accordance with some examples of the system. In example 300, software parameters 310, hardware parameters 320, model parameters 330, and hardware cost estimation 340 are provided to optimization 350, which is used to generate output 360 corresponding with hardware and model optimization configurations.

Software parameters 310 comprise software values associated with a software application, including a type of ML model, a size of data, a size of a software program, and other measurable characteristics of the software that can be stored as software parameters.

Hardware parameters 320 comprise values associated with a hardware device, including a type of hardware device, a size of memory or other device component, a speed of processor, and other measurable characteristics of the hardware that can be stored as hardware parameters.

Model parameters 330 comprise values that define the machine learning model selection (e.g., hyperparameters like topology or size of a neural network), weights, biases, values that affect the speed and quality of the learning process, or values that affect the algorithm (e.g., learning rate or size of the data sample set). In some examples, an output of the model may correspond with model parameters, for example, like a model accuracy evaluation value or other relative amount of accuracy in the output of the software (e.g., ML model, software/model parameters).

Hardware cost estimation 340 comprises, in some examples, a closed-form hardware cost model, where metrics associated with various device configurations are measured in a simulated environment that implements the device configuration with hardware and software parameters. In some examples, the hardware cost estimation corresponds with values to maximize or minimize corresponding with the hardware parameters of a device configuration, including latency (minimize), area (minimize), throughput (maximize), and other hardware cost values.

Optimization 350 comprises determining predicted metrics from the simulation that uses software parameters 310, hardware parameters 320, model parameters 330, and hardware cost estimation 340. These values may be optimized with respect to a threshold value. In some examples, the optimization may determine a model accuracy evaluation value and a hardware cost estimation value of each hardware/software/model configuration.

In some examples, the optimization of the model accuracy evaluation value and the hardware cost estimation value may be generated simultaneously. For example, the machine learning process can apply the device configuration in the simulated environment using the corresponding sets of hardware parameters and software parameters. These parameters may be applied at the same time and for a single configuration pair. Once the sets of hardware parameters and software parameters are simulated, the process can wait/delay execution of the next iteration of the process until the output is determined. In some examples, the process can wait to determine the output from the previous simulation that can help guide the selection of the next set of hardware parameters and software parameters. The selection of parameters in the two spaces of parameters (hardware and software) is performed at the same time in a joint manner, guaranteed by the Expected Improvement acquisition function.

Output 360 comprises the output of the hardware/software/model configurations that were generated in the simulated environment. The output may be used in various ways. For example, the simulated output may be used to train an ML model, which can apply weights and biases that may tune and optimize any values associated with the simulated output. The output from the ML model can determine a new device configuration that maximizes output for corresponding with hardware parameters and software parameters. For example, the new device configuration can maximize a model accuracy evaluation value and minimize a hardware cost estimation value for the new device configuration at the same time. In some examples, the output may be used to train a ML model during additional levels of training of device configurations, or may predict a device configuration that maximizes output for corresponding hardware/software parameters. These and other uses of the output configurations are provided for illustrative purposes and should not be limiting to the disclosure.

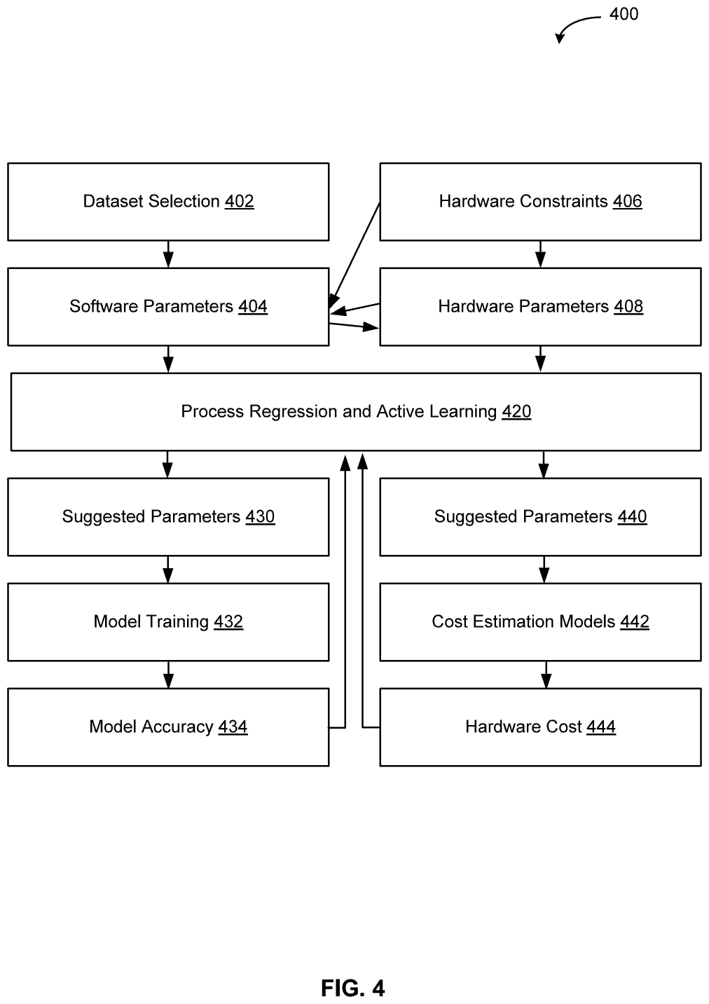

FIG. 4 illustrates a process optimization using the hardware and software co-design system, in accordance with some examples of the system. Process 400 may be executed using hardware and software co-design system 102 illustrated in FIG. 1.

At block 402, a dataset selection is determined. A dataset may comprise any collection of data in any type of industry or scope. The data may correspond with a particular time interval (e.g., time series data) or other purpose (e.g., training data, validation data, or testing data).

At block 404, software parameters are determined. The software parameters may correspond with the dataset selection (block 402). A model may be trained during the training process to fit to the training data set in accordance with the software parameters (e.g. weights of connections between the nodes of the model).

At block 406, hardware constraints are determined. In some examples, the hardware constraints correspond to the physical limitations of the device (e.g., a particular size, speed, or other value limitation as a physical constraint).

At block 408, hardware parameters are determined. The hardware parameters may correspond with the dataset selection (block 402) that executes instructions to run the software or other modules/engines. The hardware parameters may comprise values associated with a hardware device, including a type of hardware device, a size of memory or other device component, a speed of processor, and other measurable characteristics of the hardware that can be stored as hardware parameters.

As an illustrative example, dataset selection (block 402) is used by the system to determine software parameters (block 404) and hardware parameters (block 408). Hardware parameters 408 may be limited by hardware constraints (block 406). The process can sample a dataset through dataset selection (block 402) to generate software parameters (block 404) and hardware parameters (block 408), and N-corresponding device configurations using those selected parameters and in accordance with any hardware constraints (block 406).

At block 420, the process regression and active learning may be initiated. For example, process regression and active learning may comprise the machine learning process, where metrics associated with each device configuration are measured in a simulated environment. During the process regression and active learning, predicted metrics from the simulation may be determined, including a model accuracy evaluation value and a hardware cost estimation value of each device configuration.

At block 430, a next or second set of software parameters may be selected by the active learning process and, in some examples simultaneously, at block 440, a next set of hardware parameters may be selected by the active learning process. In other words, the software parameters and the hardware parameters may be selected and tested simultaneously in a combined process. In some examples, block 430 and block 440 may be implemented non-simultaneously.

In some examples, the next set of software parameters (block 430) and hardware parameters (block 440) may be selected in a sequential order by the active learning process, such that the first device configuration is measured using a first set of software parameters and a first set of hardware parameters, then a next or second configuration is simulated. In other words, the first set of software parameters may be selected, then sequentially, a second set of software parameters may be selected. Similarly, the first set of hardware parameters may be selected, then sequentially, a second set of hardware parameters may be selected.

At block 432, the process may use the next or second set of software parameters to train the ML model using active learning and, in some examples simultaneously, at block 442, the process may use the next or second set of hardware parameters to train the ML model using active learning. Process regression and active learning may determine the corresponding model accuracy (block 434) and hardware cost (block 444) of the device configuration corresponding with the simulated software parameters and hardware parameters for the next or second configuration of each the software parameters (block 430) and hardware parameters (block 440). In some examples, the input (e.g., software parameters and hardware parameters) and output (e.g., model accuracy evaluation value for software parameters and hardware cost estimation value for hardware parameters) determined from process regression and active learning may be provided to train the ML model (block 432).

At block 434, a model accuracy value is determined and, in some examples, a hardware cost value is determined simultaneously at block 444. For example, when a new set of parameters are provided to the trained ML model, the trained ML model can generate model accuracy value (block 434) and, using a cost estimation of the particular hardware configuration/parameters (block 442) that is used in the simulated environment to execute the ML model, also generate the hardware cost (block 444).

A better model accuracy evaluation value may be maximized in comparison to other model accuracy evaluation values, which can optimize the software parameters and the process can choose the most efficient/accurate software configuration. On the hardware side, the hardware cost estimation value comprises values to maximize or minimize corresponding with the hardware parameters of a device configuration, including latency (minimize), area (minimize), throughput (maximize), and other hardware cost values. A model accuracy evaluation value comprises a value corresponding with a relative amount of accuracy in the output of the software (e.g., ML model, software/model parameters) when combined with the particular configuration of the hardware processor (e.g., hardware parameters). A better model accuracy evaluation value may be maximized in comparison to other model accuracy evaluation values.

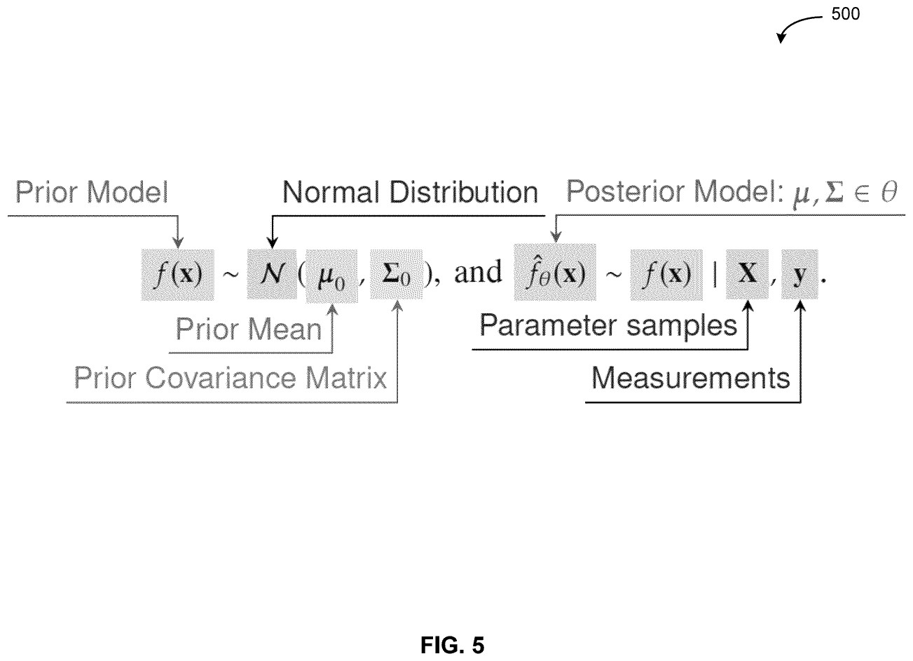

FIG. 5 illustrates a machine learning regression model, in accordance with some examples of the system. For example, the machine learning regression model may include a Gaussian Process Regression model or other machine learning regression models without diverting from the essence of the disclosure. Equation 500 may be executed using hardware and software co-design system 102 illustrated in FIG. 1.

In some examples, the system may determine the initial experiments X by sampling a joint search space of hardware and software parameters. The sampled points may be evaluated by first training a decision tree model on one or all target datasets, and then estimating hardware area, latency, and throughput using a closed-form hardware cost model. The target datasets may be selected depending on optimization target. The prior machine learning model and the posterior, conditioning on the measurements are written as equation 500.

In some examples, the machine learning process can mix hardware and software parameters from different search spaces in the same model without modifying the underlying fitting algorithm. Using the normalization strategy described in equation 500, the system may also mix metrics from different hardware and software optimization stages. This approach may be agnostic to the parameter spaces and processes used to obtain metrics, and can be applied to hardware or software search spaces, regardless of differentiability.

The normalizing strategy is described in equation 500 is one example of normalizing metrics coming from different fields (such as hardware and software). An example of a software metric is the accuracy of a tree based ML model, while an example of a hardware metric is the latency of a machine learning model accelerator. The normalization in equation 500 may remove the mean value \hat{μ}(X) from X and dividing by the standard deviation \hat{σ}(X). This may correspond to shifting the mean into “0” and modulating the standard deviation to be “1.” After different metrics have been normalized in this way, the metrics may be combined/aggregated/mixed by making sure that they have the same or substantially similar weight.

In some examples, equation 500 describes the Gaussian Process (GP) model prior and posterior. The prior ƒ(x)˜N (μ₀, σ₀) may correspond with a normal distribution, where mean μ₀ and standard deviation σ₀, while the posterior \hat{ƒ}_{θ}(x) is the prior ƒ(x) weighted by the likelihood given the parameters samples and measurements. This equation may be used for modeling the space, or in other words learning how to predict the metric (e.g. the tree based ML model accuracy, or hardware accelerator latency) given a set of parameters.

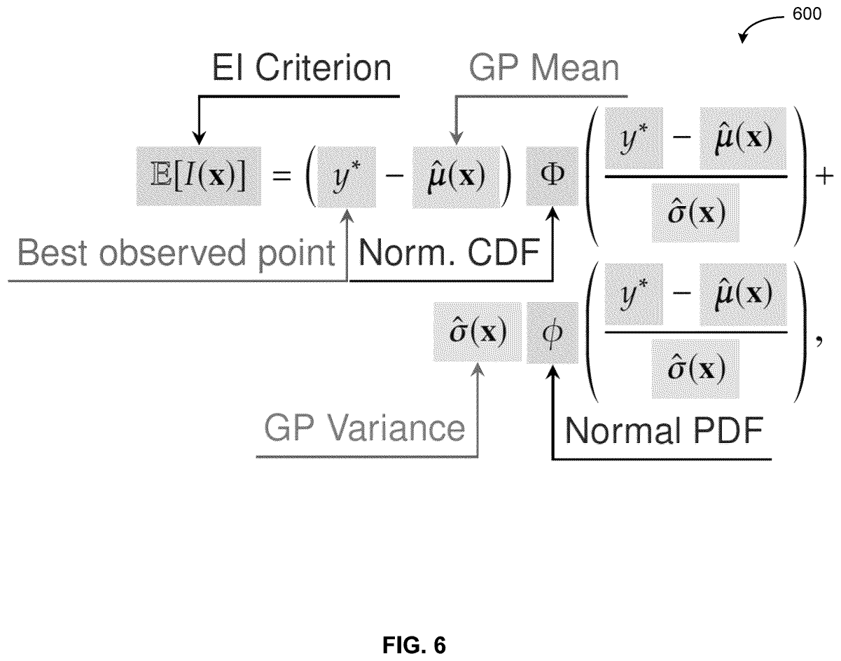

FIG. 6 illustrates an Expected Improvement (EI) Acquisition function, in accordance with some examples of the system. Equation 600 may be executed using hardware and software co-design system 102 illustrated in FIG. 1.

In some examples, equation 600 can be implemented to describe the expected improvement (EI) criterion used by the active learning optimization model. At each iteration, the process may determine a new set of input parameters that can improve metrics (e.g., such as the tree-based ML model accuracy and hardware latency). The active learning model can select the set of inputs that maximizes the EI.

In some examples, the EI criterion consists of two terms. The first weights the normal cumulative distribution function Φ by the difference of the best-observed point and the GP mean. This tells how out of the distribution the point is, promoting points that are good but in an area that has not been explored yet. The second term weights the normal probability distribution function ϕ by the Gaussian process variance so that a large variance is promoted (the space explored is larger).

In some examples, both distributions are normalized based on the equation illustrated in FIG. 5.

In some examples, the EI acquisition function is executed to compute a next point to measure among candidate points. The candidate points may be sampled uniformly in the joint space.

In some examples, Sobol' sequences may be used to sample uniformly in a high dimension to generate quasi-random low-discrepancy sequences. Sobol' sequences may be listed in base two. The use of a base of two may help form successively finer uniform partitions of the unit interval and then reorder the coordinates in each dimension.

These candidate points may not be measured and may be used to guide optimization. The use of the EI criterion to guide an optimization model as part of the active learning process. The EI criterion is written as equation 600. The next point x^{N+1} after N experiments, is written argmaxₓ E[I(y, x)].

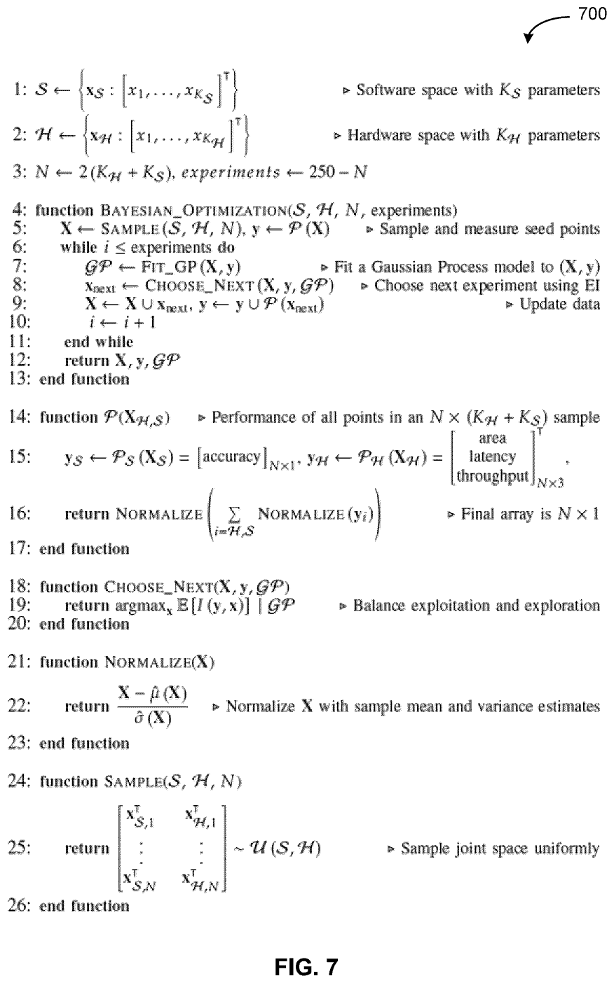

FIG. 7 illustrates example pseudo-code of computer readable instructions for level-two co-design using a machine learning regression process with active learning, in accordance with some examples of the system. Level-two co-design may comprise a joint optimization process of hardware and software, where hardware and software are optimized simultaneously and concurrently. Level-one co-design may comprise a hardware-aware optimization process that includes software optimization, hardware evaluation, and hardware optimization, each of which are optimized separately. Level-zero co-design may comprise an independent optimization process where software and hardware are optimized separately. Computer readable instructions 700 may be executed using hardware and software co-design system 102 illustrated in FIG. 1.

The instructions may illustrate a portion of the overall process for the level-two co-design using the linear regression process with active learning. A similar approach may be used for level-one co-design with one linear regression process for each separate space.

In this example, the joint and separate space co-design settings are illustrated. The co-design approach enabled the exploration of two aspects of the interaction between hardware and software parameters.

In some examples of the separate hardware and software co-design, the process may train and optimize decision tree models and later optimize specialized hardware for each model, exploring the impact of hardware configuration on model performance (level-one: Hardware-aware optimization). Since the application domain is fixed in this setting we can also optimize a generalized hardware implementation, capable of running all trained ML models, where hardware performance is averaged over all models. In co-design works that target already-developed architectures such as GPUs, hardware configuration does not typically restrict the application domain, but since this paper deals with a new architecture developed from scratch, we have the freedom to explore generalization or specialization based on performance requirements and software domains of interest.

We then explore joint hardware and software co-design, where model and hardware parameters are merged in a single larger search space, and we optimize both parameter sets in the same optimization loop (level-two: True Hardware/Software co-design). This joint exploration enables exposing trade-offs between hardware and software performance that could be explored in the separate co-design setting, since the optimizer on the software side is not capable of influencing directly the parameter choices of the optimizer on the second stage. We did not explore hardware generalization in this setting, since although the same set of hardware parameters can generate hardware that supports all models, it does not make sense to optimize all models with the same set of software parameters. Hardware generalization for joint space co-design would require a more complex approach than the one presented in this paper.

Computer readable instructions 700 may describe a linear regression process (e.g., Bayesian Optimization algorithm using the GP Regression models) implemented in the GPyTorch package and the EI acquisition function from the BoTorch package, both running natively on hardware devices (e.g., GPUs or other processors). The pseudo-code of computer readable instructions for level-two co-design using a machine learning regression process with active learning is described herein, in association with the lines of pseudo code illustrated in the example.

At lines 1 and 2, the software space and the hardware space are initiated with parameters, respectively. For example, the software space S is initiated with Kₛ parameters and the hardware space is initiated with K_{H} parameters.

At line 3, the software space and the hardware space are combined to generate an input for the Bayesian Optimization function.

At line 4, the first function is defined as accepting four inputs, including the software space and the hardware space defined at lines 1 and 2, the combined software space and hardware space, and an “experiments” variable. The first function may correspond with a Bayesian Optimization function

At line 5, the first function may sample and measure the seed points.

At line 6, the first function may define a “while” clause. For example, while the variable “i” is less than or equal to the “experiments” variable, execute lines 7-11.

At line 7, the first function may fit the Gaussian Process model to (X, y).

At line 8, the first function may choose the next experiment using the Expected Improvement (EI) criterion.

At line 9, the first function may update the data.

At line 10, the first function may iterate to the next experiment.

At line 11, the first function may end the “while” clause.

At line 12, the first function may return values and data associated with the determined variables.

At line 13, the first function may end.

At line 14, the second function is defined. The second function may define the performance of points in a particular sample space, including N×(Kₛ+K_{H}).

At line 15, the second function may perform various operations in association with the area, latency, and throughput of the defined parameters.

At line 16, the second function may return a normalized value.

At line 17, the second function may end.

At line 18, the third function is defined, which is called in the first function at line 8.

At line 19, the third function may return a maximum value in a set of values. The third function may balance exploitation and exploration.

At line 20, the third function may end.

At line 21, the fourth function is defined, which is called in the second function at line 16.

At line 22, the fourth function may determine a normalized X sample space with a sample mean and variance estimates. The value may be returned.

At line 23, the fourth function may end.

At line 24, the fifth function is defined, which is called in the first function at line 5.

At line 25, the fifth function returns a matrix multiplication value associated with the sample joint space uniformly.

At line 26, the fifth function may end.

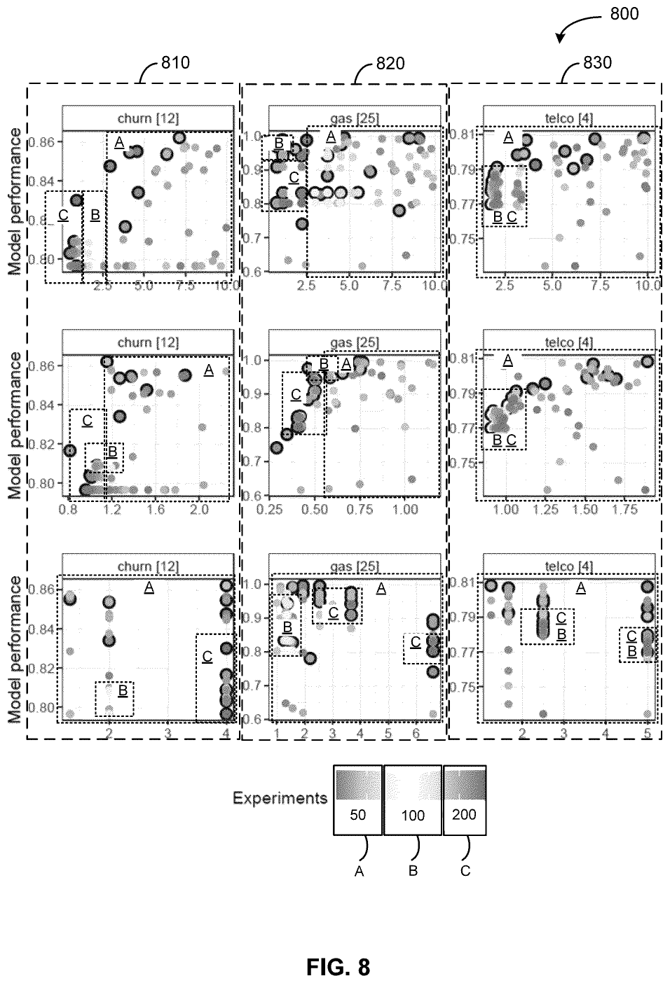

FIG. 8 illustrates optimization metrics, in accordance with some examples of the system. In example 800, optimization metrics are provided that correspond with various hardware and software parameters. The ML model may display the optimized device configuration by highlighting the combination of hardware and software parameters with a black outline around the best trade-off for these parameters. In other words, the hardware and software parameters could not be improved on any of the four metrics without “paying” something on the other three.

In some examples, the display shows a progressive color scale that is converted to dashed boxes in the diagram labeled “A,” “B,” and “C.” As the experiments are executed, the values that compare model performance with each perspective are mapped on the chart. When approximately fifty experiments are executed, the approximate area is identified on each chart as “A.” When approximately one hundred experiments are executed, the approximate area is identified on each chart as “B.” When approximately two hundred experiments are executed, the approximate area is identified on each chart as “C.” In the abstract, the color (and converted ABC labels) shows that the optimization process can finish on points that exploit the structure in the parameter space and concurrently define parameters to optimize each one in view of the overall benefit to the device configuration.

For example, example 800 may provide different views of the same data set. For example, at block 810, the model may be receive a single data set three times and the results of the optimizer are provided from three different perspectives, including area ratio (top), latency ratio (middle), and throughput ratio (bottom). At block 820, the model may be receive a single data set three times and the results of the optimizer are provided from three different perspectives, including area ratio (top), latency ratio (middle), and throughput ratio (bottom). At block 830, the model may be receive a single data set three times and the results of the optimizer are provided from three different perspectives, including area ratio (top), latency ratio (middle), and throughput ratio (bottom).

The three data sets (shown at block 810, 820, 830) may be analyzed from the different perspectives. For area ratio (top), the model may determine how the area ratio relates to the model performance. For latency ratio (middle), the model may determine how the latency ratio relates to the model performance. For throughput ratio (bottom), the model may determine how the throughput ratio relates to the model performance. In some examples, area, latency, and throughput may be associated with hardware metrics that are measured at the same time as software metrics.

In some examples, as the system performs more experiments, the values are measured at particular areas of the chart. This may identify that compromises are made with respect to model performance and the measured perspective. For example, as the hardware area becomes smaller, the model accuracy may be reduced slightly with also a reduced latency. The model accuracy may be maximized with respect to the other values.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

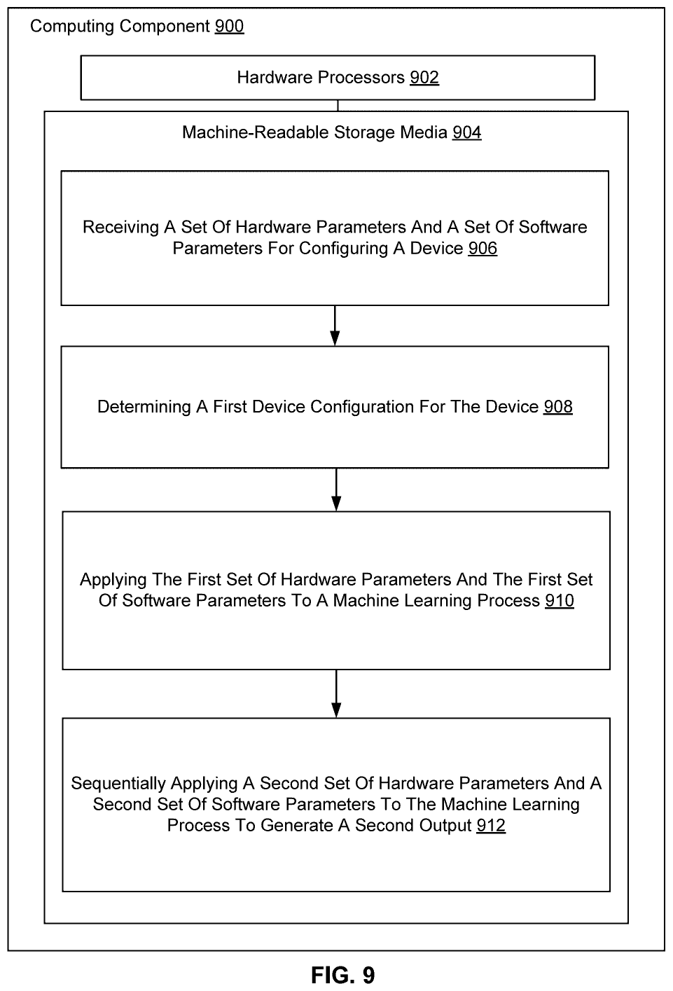

FIG. 9 illustrates an example computing component that may be used to implement burst preloading for available bandwidth estimation in accordance with various embodiments. Referring now to FIG. 9, computing component 900 may be, for example, a server computer, a controller, or any other similar computing component capable of processing data. In the example implementation of FIG. 9, the computing component 900 includes a hardware processor 902, and machine-readable storage medium for 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 906-912, to control processes or operations for burst preloading for available bandwidth estimation. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 904 may be a non-transitory storage medium, where the term “non-transitory”does not encompass transitory propagating signals. As described in detail below, machine-readable storage medium 904 may be encoded with executable instructions, for example, instructions 906-912.

Hardware processor 902 may execute instruction 906 to receive a set of hardware parameters and a set of software parameters for configuring a device. For example, hardware processor 902 may sample a search space of hardware and software configurations to determine software parameters and/or hardware parameters. The software parameters comprise values associated with a software application, including a type of ML model, a size of data, a size of a software program, and other measurable characteristics of the software that can be stored as software parameters. Hardware parameters comprise values associated with a hardware device, including a type of hardware device, a size of memory or other device component, a speed of processor, and other measurable characteristics of the hardware that can be stored as hardware parameters.

Hardware processor 902 may execute instruction 908 to determine a first device configuration for the device. The first device configuration may be determined from the set of hardware parameters and the set of software parameters. In an illustrative example, the latency, area, and throughput of the first device configuration may be determined/estimated using a closed-form hardware cost model, where metrics associated with the first device configuration are measured in a simulated environment that implements the device configuration with hardware and software parameters.

Hardware processor 902 may execute instruction 910 to apply the first set of hardware parameters and the first set of software parameters to a machine learning process. The model may be a machine learning regression process. The ML process may be implemented in a simulated or virtual environment using the software parameters and hardware parameters determined from the configuration sample, and used to generate metrics associated with the first device configuration. In some examples, the machine learning process is a Gaussian Process regression with active learning, although other forms of machine learning processes may be implemented without diverting from the disclosure.

Hardware processor 902 may execute instruction 912 to sequentially apply a second set of hardware parameters and a second set of software parameters to the machine learning process to generate a second output. The machine learning process may iteratively and sequentially simulate various device configurations with different hardware and software parameters.

The predicted metrics from the simulation may comprise a model accuracy evaluation value and a hardware cost estimation value of each device configuration. A model accuracy evaluation value comprises a value corresponding with a relative amount of accuracy in the output of the software (e.g., ML model, software/model parameters) when combined with the particular configuration of the hardware processor (e.g., hardware parameters). A better model accuracy evaluation value may be maximized in comparison to other model accuracy evaluation values. On the hardware side, the hardware cost estimation value comprises values to maximize or minimize corresponding with the hardware parameters of a device configuration, including latency (minimize), area (minimize), throughput (maximize), and other hardware cost values.

The model accuracy evaluation value and the hardware cost estimation value may be generated simultaneously. For example, the machine learning process can apply the device configuration in the simulated environment using the corresponding sets of hardware parameters and software parameters. These parameters may be applied at the same time and for a single configuration pair.

Once the sets of hardware parameters and software parameters are simulated, the process can wait/delay execution of the next iteration of the process until the output is determined. In some examples, the process can wait to determine the output from the previous simulation that can help guide the selection of the next set of hardware parameters and software parameters. The selection of parameters in the two spaces of parameters (hardware and software) is performed at the same time in a joint manner, guaranteed by the Expected Improvement acquisition function. The simulated output may be used in various ways. For example, the simulated output may be used to train an ML model, which can apply weights and biases that may tune and optimize any values associated with the simulated output.

In some examples, the output from the ML model can determine a new device configuration that maximizes output for corresponding with hardware parameters and software parameters. For example, the new device configuration can maximize a model accuracy evaluation value and minimize a hardware cost estimation value for the new device configuration at the same time. In some examples, the output may be used to train a ML model during additional levels of training of device configurations, or may predict a device configuration that maximizes output for corresponding hardware/software parameters.

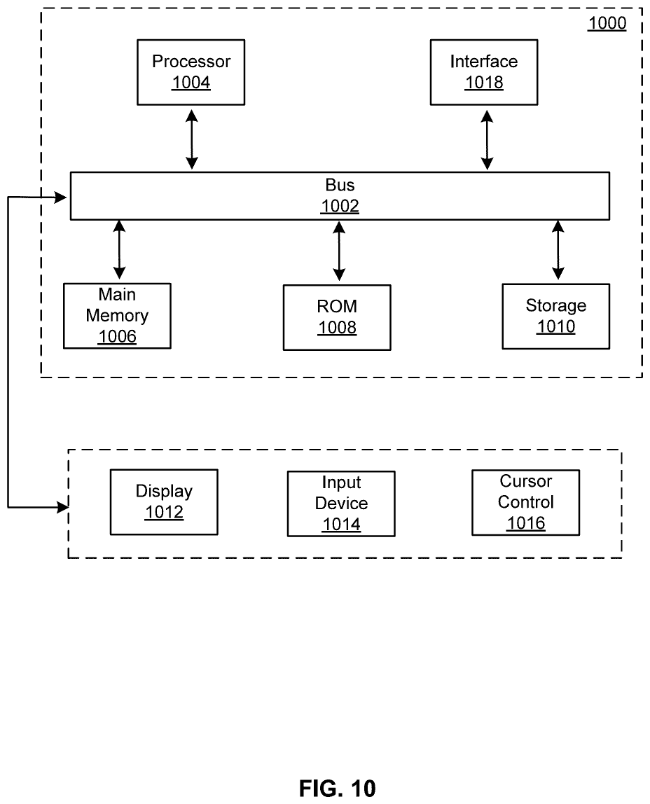

FIG. 10 depicts a block diagram of an example computer system 1000 in which various of the embodiments described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computer system 1000 may be coupled via bus 1002 to a display 1012, such as a liquid crystal display (LCD) (or touch screen), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. In some embodiments, the same direction information and command selections as cursor control may be implemented via receiving touches on a touch screen without a cursor.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes interface 1018 coupled to bus 1002. Interface 1018 provides a two-way data communication coupling to one or more network links that are connected to one or more local networks. For example, interface 1018 may be an integrated services digital network (ISDN) card, cable modem, satellite modem, or a modem to provide a data communication connection to a corresponding type of telephone line. As another example, interface 1018 may be a local area network (LAN) card to provide a data communication connection to a compatible LAN (or WAN component to communicated with a WAN). Wireless links may also be implemented. In any such implementation, interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 1018, which carry the digital data to and from computer system 1000, are example forms of transmission media.

The computer system 1000 can send messages and receive data, including program code, through the network(s), network link and interface 1018. In the Internet example, a server might transmit a requested code for an application program through the Internet, the ISP, the local network and interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving a set of hardware parameters and a set of software parameters for configuring a device;
determining a first device configuration for the device using a first set of hardware parameters from the set of hardware parameters and a first set of software parameters from the set of software parameters;
applying the first set of hardware parameters and the first set of software parameters to a machine learning process, wherein a first output from the machine learning process comprises a first software model accuracy evaluation value for the first set of hardware parameters from the set of hardware parameters and a first hardware cost estimation value for the first set of software parameters from the set of software parameters,
wherein the first output from the machine learning process simultaneously determines the first software model accuracy evaluation value and the first hardware cost estimation value for the first device configuration; and
sequentially applying a second set of hardware parameters and a second set of software parameters to the machine learning process to generate second output from the machine learning process.

2. The method of claim 1, further comprising:
training a machine learning (ML) model during a first level of training using the first device configuration based on the first set of hardware parameters, the first set of software parameters, and the first output from applying the first set of hardware parameters and the first set of software parameters to the machine learning process;
training the ML model during a second level of training using a second device configuration, the second set of hardware parameters, the second set of software parameters, and the second output; and
using the trained ML model to predict a third device configuration that maximizes output for corresponding with hardware parameters and software parameters.

3. The method of claim 1, wherein the machine learning process is a Bayesian Optimization process with a Gaussian Process Regression.

4. The method of claim 1, wherein the first output comprises a latency, an area, and a throughput of the first device configuration that are measured in a simulated environment that implements the first device configuration with the first hardware parameters and the first software parameters.

5. The method of claim 1, wherein the first output is generated using a closed-form hardware cost model of the machine learning process.

6. The method of claim 1, wherein the first set of hardware parameters, the first set of software parameters, the second set of hardware parameters, and the second set of software parameters are selected using an active learning process.

7. The method of claim 1, wherein the first set of hardware parameters and the first set of software parameters are provided back to the machine learning process to sequentially determine optimization values of different configuration settings.

8. The method of claim 1, further comprising:
stopping the determining of device configurations when the output corresponding with the hardware parameters and the software parameters exceeds a pre-determined threshold value.

9. A computer system comprising:
a memory; and
one or more processors that are configured to execute machine readable instructions stored in the memory for causing the processor to:
receive a set of hardware parameters and a set of software parameters for configuring a device;
determine a first device configuration for the device using a first set of hardware parameters from the set of hardware parameters and a first set of software parameters from the set of software parameters;
apply the first set of hardware parameters and the first set of software parameters to a machine learning process, wherein first output from the machine learning process comprises a first software model accuracy evaluation value for the first set of hardware parameters from the set of hardware parameters and a first hardware cost estimation value for the first set of software parameters from the set of software parameters,
wherein the first output from the machine learning process simultaneously determines the first software model accuracy evaluation value and the first hardware cost estimation value for the first device configuration; and
sequentially apply a second set of hardware parameters and a second set of software parameters to the machine learning process to generate second output from the machine learning process.

10. The computer system of claim 9, wherein the processor is further to:
train a machine learning (ML) model during a first level of training using the first device configuration based on the first set of hardware parameters, the first set of software parameters, and the first output from applying the first set of hardware parameters and the first set of software parameters to the machine learning process;
train the ML model during a second level of training using a second device configuration, the second set of hardware parameters, the second set of software parameters, and the second output; and
use the trained ML model to predict a third device configuration that maximizes output for corresponding with hardware parameters and software parameters.

11. The computer system of claim 9, wherein the machine learning process is a Bayesian Optimization process with a Gaussian Process Regression.

12. The computer system of claim 9, wherein the first output comprises a latency, an area, and a throughput of the first device configuration that are measured in a simulated environment that implements the first device configuration with the first hardware parameters and the first software parameters.

13. The computer system of claim 9, wherein the first output is generated using a closed-form hardware cost model of the machine learning process.

14. The computer system of claim 9, wherein the first set of hardware parameters, the first set of software parameters, the second set of hardware parameters, and the second set of software parameters are selected using an active learning process.

15. The computer system of claim 9, wherein the first set of hardware parameters and the first set of software parameters are provided back to the machine learning process to sequentially determine optimization values of different configuration settings.

16. The computer system of claim 9, wherein the processor is further to:
stop the determining of device configurations when the output corresponding with the hardware parameters and the software parameters exceeds a pre-determined threshold value.

17. A non-transitory computer-readable storage medium storing a plurality of instructions executable by a processor, the plurality of instructions when executed by the processor causes the processor to:
receive a set of hardware parameters and a set of software parameters for configuring a device;
determine a first device configuration for the device using a first set of hardware parameters from the set of hardware parameters and a first set of software parameters from the set of software parameters;
apply the first set of hardware parameters and the first set of software parameters to a machine learning process, wherein first output from the machine learning process comprises a first software model accuracy evaluation value for the first set of hardware parameters from the set of hardware parameters and a first hardware cost estimation value for the first set of software parameters from the set of software parameters,
wherein the first output from the machine learning process simultaneously determines the first software model accuracy evaluation value and the first hardware cost estimation value for the first device configuration; and
sequentially apply a second set of hardware parameters and a second set of software parameters to the machine learning process to generate second output from the machine learning process.

18. The non-transitory computer-readable storage medium of claim 17, further comprising:
train a machine learning (ML) model during a first level of training using the first device configuration based on the first set of hardware parameters, the first set of software parameters, and the first output from applying the first set of hardware parameters and the first set of software parameters to the machine learning process;
train the ML model during a second level of training using a second device configuration, the second set of hardware parameters, the second set of software parameters, and the second output; and
use the trained ML model to predict a third device configuration that maximizes output for corresponding with hardware parameters and software parameters.

19. The non-transitory computer-readable storage medium of claim 17, wherein the machine learning process is a Bayesian Optimization process with a Gaussian Process Regression.

20. The non-transitory computer-readable storage medium of claim 17, wherein the first output comprises a latency, an area, and a throughput of the first device configuration that are measured in a simulated environment that implements the first device configuration with the first hardware parameters and the first software parameters.
